(19) United States
(12) Patent Application Publication
(10) Pub. No.: US 2005/0109177 A1
(43) Pub. Date: May 26, 2005

(54) Rotary large diameter fiber cleaver

(76) Inventors: Robert G. Wiley, Frankfort, KY (US); Brett Clark, Whites Creek, TN (US); Jared Meitzler, Spring Hill, TN (US); Roberto Rivera, Franklin, TN (US); Clyde J. Troutman, Madison, AL (US)

Correspondence Address: David M. Mello;McDermott, Will & Emery, 28 State Street, Boston, MA, 02109, US

(21) Appl. No.: 10/924,434

(22) Filed: Aug. 23, 2004

Related U.S. Application Data
(60) Provisional application No. 60/579,856, filed on Jun. 15, 2004.
(60) Provisional application No. 60/497,152, filed on Aug. 22, 2003.

(51) Int. Cl. B26D 1/00

(52) U.S. Cl. 83/13

(57) ABSTRACT

A system and method for cleaving an optical fiber having a first end and a second end are provided, including circumferentially scoring the outer surface of the optical fiber with at least one blade and applying tension to at least the first end or the second end of the optical fiber until the optical fiber cleaves.

### CROSS REFERENCE TO RELATED APPLICATIONS

This application claims the benefit of priority under 35 U.S.C. §119(e) from co-pending, commonly owned U.S. provisional patent application Ser. No.60/579,856, entitled Rotary Large Diameter Fiber Cleaver, filed Jun. 15, 2004, and U.S. provisional patent application Ser. No. 60/497,152, entitled Rotary Large Diameter Fiber Cleaver, filed Aug. 22, 2003.

### FIELD OF INTEREST

The present inventive concepts relate to the field systems and methods for preparing optical fibers for use in any of a number of applications. More specifically, the present invention relates to systems and methods for “cleaving” optical fibers.

### BACKGROUND

It is the goal of many within the telecommunications industry to accurately cleave fibers of larger and larger diameters. For example, many would like to accurately cleave fibers of diameters greater 600 microns (μm), and others want to cleave fibers with diameters of over 1 mm. It is envisioned that, in addition to traditionally dimensioned fibers (e.g., about 125 μm), cleaving of these larger diameters fibers, and perhaps even larger fibers, will persist.

The accuracy of a fiber cleave is viewed as a measure of the angle of the cleave relative to a normal line taken from the direction of the fiber length. Thus, a 0 degree cleave, which would be perfectly normal to the fiber, is ideal. That ideal has not practically been achievable, but the closer to that ideal—the better.

There are generally two types of fiber cleavers within the telecommunications industry. The first type of cleaver uses a diamond rotary blade to score the glass at a point or small line and then a perpendicular force is applied to the opposite side to cause the micro cracks created by the rotary blade to propagate. This type of cleaver is not useful when trying to cleaver fibers of >300 microns, because it does not consistently generate cleave angles of less than 1° and typically will cause hackle (i.e., uneven surface in the end face of the glass). The second type of fiber cleaver applies a tension to the fiber and then a vibrating diamond blade contacts the fiber perpendicular to the tension. This type of cleaver generally creates a higher-quality cleave, but it is typically limited to cleaving fibers of less than 400 microns in diameter. This limitation is caused by the extreme tension required to cause the crack to propagate. For example, 200 g of tension is required to cleave a fiber of 125 microns diameter and 540g of tension is required to cleave a fiber of 300 microns diameter. Therefore, it is easy to see that extreme tensions in excess of 1 kg would be required to cleave fibers >400 microns diameter. These extreme tensions also can cause hackle in the fiber end face.

### SUMMARY OF INVENTION

In one aspect of the invention, provided is a method for cleaving an optical fiber having a first end and a second end, the method comprising the steps of circumferentially scoring the outer surface of the optical fiber with at least one blade and applying tension to at least the first end or the second end of the optical fiber until the optical fiber cleaves.

In another aspect of the present invention a system is provided for cleaving an optical fiber having a first end and a second end, the system comprising a holder configured to hold the fiber first end, a rotator configured to effect a circumferential rotation of the fiber relative to a blade in contact with an outer surface of the fiber, and a clamp coupled to a tensioner configured to apply tension to the second end of the fiber.

In yet another aspect of the present invention a system is provided for cleaving an optical fiber having a first end and a second end, the system comprising a scoring means for circumferentially scoring the outer surface of the optical fiber with at least one blade, and a tension means for applying tension to at least the first end or the second end of the optical fiber until the optical fiber cleaves.

In yet another aspect of the invention, a computer readable media embodies a program of instructions executable by a processor to perform a method of cleaving an optical fiber with a blade and a tensioner, the optical fiber having a first end and a second end, the method comprising circumferentially scoring the outer surface of the optical fiber with the blade, and applying tension with the tensioner to at least the first end or the second end of the optical fiber until the optical fiber cleaves.

### BRIEF DESCRIPTION OF THE DRAWINGS

The drawing figures depict preferred embodiments by way of example, not by way of limitations. In the figures, like reference numerals refer to the same or similar elements.

FIG. 1 is a method of cleaving a fiber in accordance with the present invention.

FIG. 2A is a block diagram of an illustrative embodiment if a rotary cleaver configured to implement the method of FIG. 1.

FIG. 2B is a diagram depicting the offset and accuracy angle of a scribed fiber.

FIG. 3A is a is a block diagram of an illustrative embodiment if a rotary cleaver configured to implement the method of FIG. 1.

FIG. 3B and FIG. 3C are views of components of FIG. 3A.

### DETAILED DESCRIPTION OF PREFERRED EMBODIMENT

In accordance with various aspects of the present invention, an optical fiber is cleaved by scoring about its circumference and then applying tension to at least one end of the fiber, where such tension is sufficient to propagate a crack from the score through the fiber.

For example, in one aspect of the present invention, it is feasible that one could create a device that scores the fiber cylindrically from one degree to 360°. This can be accomplished by putting the fiber in contact with a blade and rotating the fiber and/or blade relative to each other. In such a case, the blade could be a diamond blade, known in the art. The scoring process should be completed prior to exerting any significant load to the fiber. After the scoring process is complete a load can then be applied to the fiber which will cause the crack to propagate. A crack propagating through silica glass will typically follow the path of least resistance, scoring that fiber cylindrically insures that the path of least resistance is at an angle of less than about 1°.

A second advantage to cylindrical scoring is that a lower tension is required to cause the crack to propagate. This phenomenon is caused by the fact that a crack will always propagate from the most severe micro crack when perpendicular tension is applied. The surface area of glass that comes into contact with the blade is at least an order of magnitude larger with this approach than with the single contact approach and will therefore cause at least an order of magnitude more micro cracks. Since the fiber will be in motion, relative to the blade, the micro cracks will be more severe then they would be with older style cleavers. The increase in quantity and severity of the micro cracks will significantly reduce the tension required to cause a crack to propagate, and therefore minimizes the risk of “hackle” and other non-desirable phenomenon.

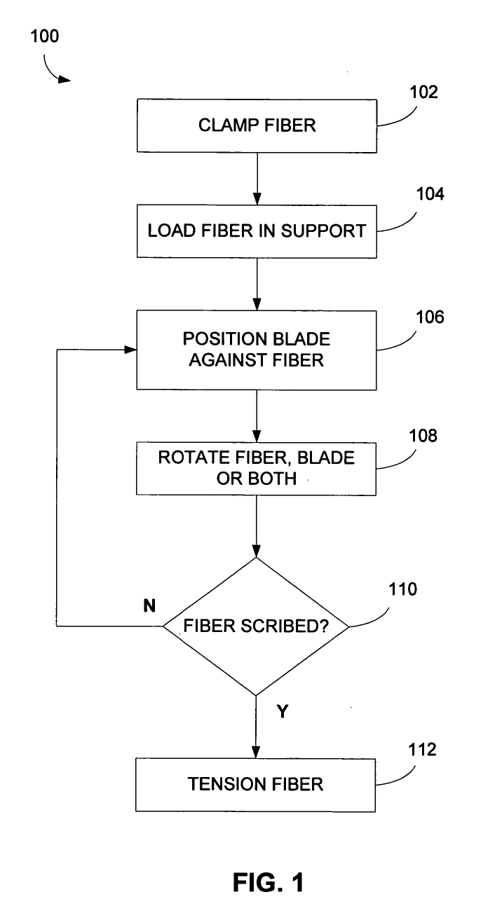

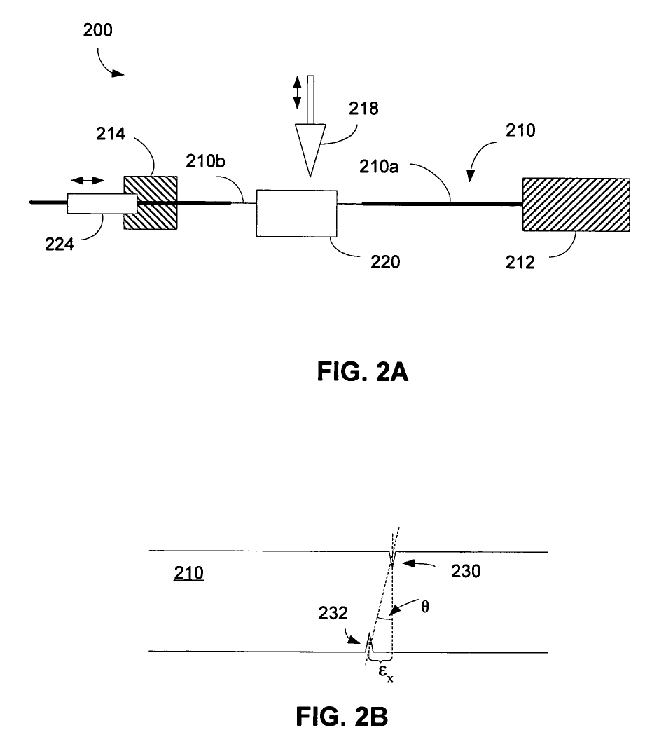

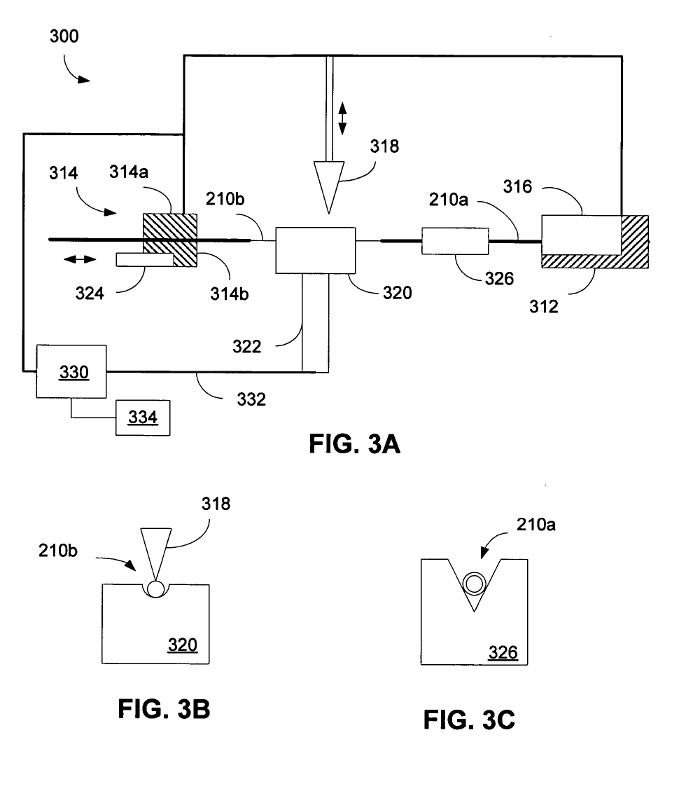

Regardless of the physical form of a rotary cleaver, such as those illustrative embodiment of FIG. 2A and FIG. 3A, the illustrative method 100 is shown in FIG. 1 may be used to cleave a fiber in accordance with the present invention. According to method 100, in step 102 a waste end of the fiber clamped. In step 104, the fiber is loaded into a holder for support during scoring. In step 106, the blade contacts the fiber and in step 108 the fiber, blade or both are rotated to circumferentially score the fiber. In step 110, a determination is made of whether or not the fiber has been circumferentially scribed. If not, the process continues to step 106 and repeats. If the answer is yes, then the process continues to step 112, where tension is applied to one end of the fiber until a crack caused at the scribed portion propagates through the fiber to create a cleave. Scribing may be continuous, around the entire circumference of the fiber, or it may be at various points along the circumference of the fiber. In the continuous case, the scribing may take the form of a continuous motion, or successive smaller motions.

One can also envision a system and method that causes the steps to occur automatically at the push of a button, under the control of software, and possibly in response to feedback obtained during the process.

FIG. 2A shows an illustrative embodiment of a rotary cleaver 200 in accordance with the present invention. In FIG. 2A, the rotary cleaver 200 is configured to cleave an optical fiber 210, which includes a coated portion 210a and a stripped portion 210b. In the illustrative embodiment, as is customary, the cleave occurs at the stripped portion 210a of the optical fiber. The simplest embodiment of this design comprises four components:
1. Rotator 212—a device to rotate the fiber. It is important that this device not cause any horizontal vertical or lateral movement in the fiber. These devices are commonly available. For example, there is one installed in the Ericsson 995 PM fusion splicer. Rotator 212 may includes means configured to hold the fiber 210 during operation.
2. Blade 218—preferably a diamond blade, or its functional equivalent. Diamond blades are commonly available and have been used in the cleaving industry for many years. Since the rotation of the fiber 210 may cause the blade 218 to wear more quickly, a more rugged blade or a blade with a larger surface area may desirable to minimize maintenance of the blade over may uses.
3. Fiber holder 220—a device to hold the fiber 210 during scoring. In this embodiment, the waste end of the fiber, i.e., the end held by rotator 212, is held during the scoring process. Fiber holder 220 preferably prevents horizontal vertical and lateral movement of the fiber 210, while allowing the fiber 210 to rotate. This can be accomplished by using a low friction clamp or by using a V-groove holder with liquid in it, as examples. If used, the surface tension of the liquid will cause the fiber 210 to stick to the base of the V-groove while allowing the fiber 210 to rotate.
4. Tensioner 224—a device to apply tension to the fiber 210, preferably after scoring. Fiber tensioning devices are common in the industry and are otherwise known as fiber tensile testers. These tensile testers can achieve loads of several kilograms and have fiber clamping mechanisms designed for such a load, such as clamp 214. The clamping mechanism 214 should not cause any rotational torque in the glass during the tensioning process. Therefore, linear clamps are more desirable than mandrel style clamps, in the illustrative embodiment.

The above embodiment the fiber 210 could be clamped at two points with a rigid cylindrical rotary frame. A small amount of tension would be initially applied to hold the fiber 210 straight and accurately located to the blade 218. In order to provide consistent contact with the blade 218, as an improvement, two sensing technologies could be used, either separately or in conjunction.

A first sensing means could be based on the use of a vibrating, piezo-type blade as a scribing mechanism. The drive signal to the piezo actuator could be configured to detect very slight physical contact with the blade. When driven from a high impedance source at its frequency of primary resonance (e.g., ˜240 Hz), this type of piezo actuator (i.e., parallel, bending actuator) exhibits 180° of phase shift between the voltage applied and the resulting current.

When forces subjectively estimated at less than about 5 mN are applied to the blade edge with a 125 μm fiber, a change in phase shift of about 20° or more occurs. This response is not linear as the force is increased, but the initial sensitivity was quite high. This appears to be a useful method of detecting blade contact with the fiber 210. However, the blade is normally operated at about 700 Hz, i.e., well away from the primary resonance. It is not known how the change in frequency will affect blade motion and the resulting scribes/cleaves.

A second sensing means monitors the change in axial tension of the fiber 210 caused by the lateral displacement of the tensioned fiber at the scribe point. This is a “leveraged” force, as relatively small scribing forces cause larger increases in the axial tension. The axial tension sensing method was tested in an existing cleaver with load cell-based sensing of fiber tension. Estimated transverse forces of 20 mN produced measurable changes (i.e., about 1 mV) in the output from the load cell amplifier. The force required to cleave a 300 μm fiber produced a deflection of approximately 5 mV, as observed on an oscilloscope. This second sensing means appears to offer reduced sensitivity, but greater linearity, than the piezo drive signal monitoring.

FIG. 2B shows a view of a fiber scribed, such as fiber 210 shown FIG. 2A. Here, there is an offset, given by εₓ, between a first scribe 230 and a second scribe 232, opposite the first scribe 230. Some amount of offset may be unavoidable, but limiting the angle (θ) of the offset to be, for example, less than about 10 is valuable, particularly with larger diameter fibers. As can be seen from Table 1 below, the above illustrative embodiment produces such results.

To achieve the results of Table 1, a rotary mechanism of an Ericsson 995PM splicer was attached to a standard wheel cleaver to cylindrically score fiber 210. Using the menu functions on the splicer the fiber 210 was rotated while in contact with the cleaver blade. After the fiber 210 was scored cylindrically, the fiber 210 was placed in a linear tensile tester to apply the necessary load to cause the cracks to propagate.

TABLE 1

| Fiber | Cleave angle |
|---|---|
| Diameter | (θ) |
| 125 μm | 0.2 |
| 125 μm | 0.15 |
| 125 μm | 0.34 |
| 125 μm | 0.22 |
| 125 μm | 0.44 |
| 125 μm | 0.13 |
| 125 μm | 0.2 |
| 125 μm | 0.33 |
| 125 μm | 0.17 |
| 300 μm | 0.44 |
| 300 μm | 0.31 |
| 300 μm | 0.51 |
| 300 μm | 0.26 |
| 300 μm | 0.12 |
| 300 μm | 0.3 |
| 350 μm | 0.31 |
| 350 μm | 0.22 |
| 350 μm | 0.47 |
| 350 μm | 0.18 |
| 350 μm | 0.18 |
| 350 μm | 0.36 |
| 600 μm | 0.52 |
| 600 μm | 0.67 |
| 600 μm | 0.75 |
| 600 μm | 0.66 |
| 600 μm | 0.73 |
| 600 μm | 0.46 |

As is shown above, using the illustrative system and method, for large diameter fibers, here up to 600 μm, the desired cleave angle accuracy was achieved, i.e., θ<1°. It will be appreciated by those skilled in the art, that the present invention is not limited to the specific components cited herein—they are merely provided as one example of the types of components that could be used to practice the present invention.

In another embodiment, improvements of the workability of the cylindrical frame used above can be beneficial. For example, it would be beneficial to better ensure that the fiber's axial location remains accurately placed as the rotation is made. The estimated “endplay” of the mechanism would appear to be greater than desired. Additionally, with the above approach, means of adjusting the fiber location to exactly coincide with the axis of the cylindrical frame, particularly for fibers of varying diameters, would be useful. Also, means for ensuring torsion-free clamping of non-round fibers would represent improvements.

FIG. 3A shows yet another illustrative embodiment 300 of a rotary cleaver for cleaving an optical fiber 210. In this embodiment, the rotary cleaver 300 comprises the following illustrative components:
1. Fiber holder 316—as an example, this component can be the same form-factor as standard “small/PM” Ericsson-compatible fiber holder, with an enhanced clamping mechanism, known in the art.
2. Rotator 312—for example, an Ericsson PM splicer rotator. This part is preferred for this application as it has very tight mechanical tolerances and includes a magnetic bearing system that minimizes axial shift during rotation.
3. V-Groove 326—this locates the coated portion of the fiber 210b. Optionally, a vacuum system could be used to locate the fiber. FIG. 3C shows a side view of this component with fiber 210a positioned therein.
4. Blade 318—this is the piezo-actuator/diamond blade assembly known in the art. This assembly has proven performance in cleaving a wide variety of fibers. It offers approximately 1 mm of piezo positioning and a separate stepper-motor positioner for exposing fresh areas of the blade to compensate for wear or damage.
5. Anvil 320—a grooved anvil is provided to prevent fiber bending or transverse motion during the scribing process. As it is necessary for this to touch the bare glass portion of the fiber adjacent to the cleave point, it must be made of a low-abrasion material. The illustrative material is Vespel, i.e., a polyimide-based material which exhibits precise machineability and very low friction and abrasion. FIG. 3B shows a side view of holder 320 with the blade contacting fiber 210b.
6. Load Cell 322—this is a full-bridge, thin beam load cell with expected sensitivity to about 10 mN. It senses force applied to the anvil 320 via the cleaving blade 318.
7. Clamp 314—comprising lower clamp 314a and upper clamp 314b. In this embodiment, during scribing, the distal end of the fiber 210 is supported by the lower clamp 314b, and after scribing, the upper clamp 314a is engaged to clamp the fiber for tensioning.
8. Tensioning mechanism 324—a stepper-motor-based mechanism that translates the clamp 314 away from the fiber holder 316 to apply tension for cleaving.
9. Control mechanism 330—for example, a single-board computer (SBC) used to control the device. It accepts analog inputs from the load cell and controls the various stepper motors and the piezo blade actuator, via a bus 332. Operator interface can be provided via key-switches and an LCD display 334, or any other known computer-related input and output means. A serial port can provided for programming the SBC, which can act as a controller with feedback monitoring capability.

The illustrative method of operation of rotary cleaver 300 is similar to that of rotary cleaver 200, and that described with respect to FIG. 1. But in this embodiment, a stepped approach to scribing is used. The method comprises the following steps:
1. Scribing: The fiber 210 is not tensioned during the scribing process. The V-groove assembly 326 supports and positions the fiber 210 on a grooved, low-abrasion anvil 320. The rotator mechanism 312 rotates in discrete steps of 0.5° (minimum, larger values possible). At each step, the blade 318 is advanced until it contacts the fiber 210. The method of sensing blade contact is by direct measurement of the force applied through the fiber 210 to the anvil surface 320, using a load cell 322 in the anvil support. After one or more blade contacts at a first rotational position, the blade 318 is retracted by approximately 10 μm and the fiber 210 is rotated by one step. The process is the repeated until the entire circumference is scribed. Although, in another embodiment, various points about the circumference of the fiber could be scribed. The force and displacement of the blade 318 at each step is programmable, according to the requirements of different fiber cross-sections. The actual position of the blade 318 required to initiate fiber contact at each step is recorded in the memory of the SBC 330.
2. Clamping: It is known that any torsional force present in the fiber 210 during the cleaving process will adversely affect cleave quality. Since non-circular fiber cross-sections are expected, the fiber must be positioned so that the clamping process will not twist the fiber 210. The blade-position data acquired during the scribing process is used to calculate the “flattest” orientation of the fiber. The fiber 210 is automatically rotated to this orientation to minimize torsion as the clamps 314 are closed.
3. Tensioning: As this is, in this embodiment, a tension-after-scribe system, it is preferred that this be open-loop (i.e., pull until break, without regard to tension reached). A spring or cam mechanism may be used to ensure gradual ramp-up of tension. After cleaving, the rotator 312 will return to its “home” position for removal of the fiber holder 316.
4. Programmable control: Additional operator control of rotational resolution (i.e., number of steps) and scribing action (i.e., blade displacement and number of contacts) can also be easily programmed, as will be appreciated by those skilled in the art.
5. Displayed information: LCD 334 display may be included to provide feedback on the detected fiber shape and rotational position (for process control and diagnostic purposes) and indicate to the operator when to load and remove the fiber 210.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation. It is intended by the following claims to claim any and all modifications and variations that fall within the true scope of the inventive concepts.

1. A method for cleaving an optical fiber having a first end and a second end, the method comprising the steps of:
A. circumferentially scoring the outer surface of the optical fiber with at least one blade; and
B. applying tension to at least the first end or the second end of the optical fiber until the optical fiber cleaves.

2. The method of claim 1 wherein step A comprises rotating the at least one blade relative to the fiber.

3. The method of claim 1 wherein step A comprises rotating the fiber relative to the at least one blade.

4. The method of claim 1 wherein the outer shape of the optical fiber is substantially round, hexagonal, elliptical, star, square, or rectangular.

5. The method of claim 1 wherein the fiber is greater than 300 μm in diameter.

6. The method of claim 1 wherein step A comprises scoring in steps.

7. The method of claim 1 wherein step A comprises scoring portions of the circumference of the fiber.

8. A system for cleaving an optical fiber having a first end and a second end, the system comprising:
A. a holder configured to hold the fiber first end;
B. a rotator configured to effect a circumferential rotation of the fiber relative to a blade in contact with an outer surface of the fiber; and
C. a clamp coupled to a tensioner configured to apply tension to the second end of the fiber.

9. The system of claim 8 wherein the rotator is configured to rotate the blade relative to the fiber.

10. The system of claim 8 wherein the rotator is configured to rotate the fiber relative to the blade.

11. The system of claim 8 wherein the outer shape of the optical fiber is substantially round, hexagonal, elliptical, star, square, or rectangular.

12. The system of claim 8 wherein the fiber is greater than 300 μm in diameter.

13. The system of claim 8 wherein the rotator is configured to score in steps.

14. The system of claim 8 wherein the rotator is configured to score portions of the circumference of the fiber.

15. The system of claim 8 further comprising:
D. a controller configured to selectively control at least one of the rotator, blade or tensioner.

16. A system for cleaving an optical fiber having a first end and a second end, the system comprising:
A. a scoring means for circumferentially scoring the outer surface of the optical fiber with at least one blade; and
B. a tension means for applying tension to at least the first end or the second end of the optical fiber until the optical fiber cleaves.

17. The system of claim 16 wherein the means of part A comprises means for rotating the at least one blade relative to the fiber.

18. The system of claim 16 wherein the means of part A comprises means for rotating the fiber relative to the at least one blade.

19. The system of claim 16 wherein the outer shape of the optical fiber is substantially round, hexagonal, elliptical, star, square, or rectangular.

20. The system of claim 16 wherein the fiber is greater than 300 μm in diameter.

21. The system of claim 16 further comprising a controller means for selectively controlling the scoring means and the tension means.

22. The system of claim 16 wherein the scoring means comprises means for scoring the fiber in steps.

23. The system of claim 16 wherein the rotator is configured to score portions of the circumference of the fiber.

24. Computer readable media embodying a program of instructions executable by a processor to perform a method of cleaving an optical fiber with a blade and a tensioner, the optical fiber having a first end and a second end, the method comprising:
A. circumferentially scoring the outer surface of the optical fiber with the blade; and
B. applying tension with the tensioner to at least the first end or the second end of the optical fiber until the optical fiber cleaves.
